(19) United States
(12) Patent Application Publication
(10) Pub. No.: US 2024/0406478 A1
(43) Pub. Date: Dec. 5, 2024

(54) METHOD, SERVER AND COMPUTER PROGRAM

(71) Applicant: 17LIVE Japan Inc., Tokyo (JP)

(72) Inventors: Yung-Chi HSU, Taipei City (TW); Chun-Sheng HSU, Taipei City (TW); Tsung-Tai SHIH, Taipei City (TW); Chin-Wei LIU, Taipei City (TW); Che-Wei HU, Taipei City (TW)

(21) Appl. No.: 18/513,062

(22) Filed: Nov. 17, 2023

(30) Foreign Application Priority Data
Jun. 1, 2023 (JP) 2023-091018

(51) Int. Cl. H04N 21/25; H04N 21/2187; H04N 21/431; H04N 21/4784; H04N 21/4788; H04N 21/488

(52) U.S. Cl. CPC H04N 21/251; H04N 21/2187; H04N 21/4316; H04N 21/4784; H04N 21/4788; H04N 21/4882

(57) ABSTRACT

A method for managing an event in a live streaming platform, comprising: generating a summary of the event by machine learning models in response to a first operation from a user terminal of a user; wherein the summary is generated according to information of the events, the user and the other users related to the user. The present disclosure may lower the barrier of participating in the event and encourage the interaction between livestreamers and viewers. Moreover, it may motivate the livestreamer to understand and participate in the event. Therefore, the user experience may be enhanced and the quality of the live streaming service may be improved.

### CROSS-REFERENCE TO RELATED APPLICATIONS

This application is based on and claims the benefit of priority from Japanese Patent Application Serial No. 2023-091018 (filed on Jun. 1, 2023), the contents of which are hereby incorporated by reference in its entirety.

### TECHNICAL FIELD

This disclosure relates to information and communication technology, and in particular, to a method, server and computer program in a live streaming.

### BACKGROUND

Some APPs or platforms provide live streaming service for livestreamers and viewers to interact with each other. The livestreamers may have a performance to cheer up the viewer and the viewer may send gifts to support the livestreamers.

The APPs or platform providers always hold events to motivate the interaction between livestreamers and viewers. The livestreamers may select an event and start broadcasting. In order to win the events and receive reward, the livestreamers may do their best to cheer up the viewer. Patent Document 1 disclose a scenario that the livestreamer is participating in an event and the leaderboard may be displayed on screen.

However, if there are too many events on the event lists or the description of the events are too difficult to understand, it may discourage the livestreamer from engaging in the event. What's even worse is that the livestreamer may even lose interest in viewing the description of the event. Therefore, how to improve the user experience is very important.
[Patent Document 1]: CN106803965B

### SUMMARY

An embodiment of subject application relates to a method for managing an event in a live streaming platform, comprising: generating a summary of the event by machine learning models in response to a first operation from a user terminal of a user; wherein the summary is generated according to information of the events, the user and the other users related to the user.

Another embodiment of subject application relates to a server for managing events in a live streaming platform, comprising one or a plurality of processors, wherein the one or plurality of processors execute a machine-readable instruction to perform: generating a summary of the event by machine learning models in response to a first operation from a user terminal of a user; wherein the summary is generated according to information of the events, the user and the other users related to the user.

Another embodiment of subject application relates to a computer program for causing a server to realize the functions of: generating a summary of the event by machine learning models in response to a first operation from a user terminal of a user; wherein the summary is generated according to information of the events, the user and the other users related to the user.

The present disclosure may lower the barrier of participating in the event and encourage the interaction between livestreamers and viewers. Moreover, it may motivate the livestreamer to understand and participate in the event. Therefore, the user experience may be enhanced and the quality of the live streaming service may be improved.

### BRIEF DESCRIPTION OF THE DRAWINGS

FIG. 1 is a schematic configuration of a live streaming system 1 according to some embodiments of subject application;

FIG. 2 is a schematic block diagram of the user terminal 20 according to some embodiments of subject application;

FIG. 3 is a schematic block diagram of the server 10 according to some embodiments of subject application;

FIG. 4 shows an exemplary data structure of the stream DB 320 of FIG. 3;

FIG. 5 shows an exemplary data structure of the user DB 322 of FIG. 3;

FIG. 6 shows an exemplary data structure of the donation record in the user DB 322;

FIG. 7 shows an exemplary data structure of the winning record in the user DB 322;

FIG. 8 shows an exemplary data structure of the event DB 324 of FIG. 3;

FIG. 9 shows an exemplary data structure of the historical record DB 326 of FIG. 3;

FIG. 10-FIG. 12 are exemplary functional configurations of the live streaming system 1 according to some embodiments of subject application;

FIG. 13-FIG. 17 are exemplary screen images of a live-streaming room screen 600 shown on the display of the livestreamer user terminal 20 or the viewer user terminal 30;

FIG. 18 and FIG. 19 are flowcharts showing steps of an operation of the configuration of the live streaming system 1 according to some embodiments of subject application;

FIG. 20 is an exemplary hardware configuration of the information processing device according to some embodiments of subject application.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

The live streaming system 1 according to some embodiments of subject application provides enhancement among the users to communicate and interact smoothly. More specifically, it entertains the viewers and livestreamers in a technical way.

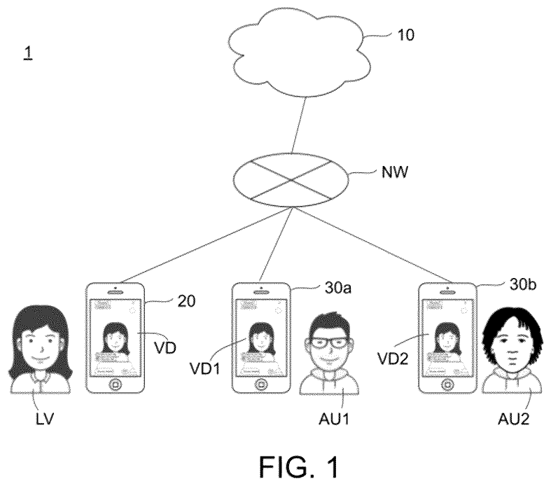

FIG. 1 shows a schematic configuration of a live streaming system 1 according to some embodiments of subject application. The live streaming system 1 provides a live streaming service for the streaming livestreamer (may also be referred as liver, streamer or livestreamer) LV and viewer (may also be referred as audience) AU (AU1, AU2 . . . ) to interact mutually in real time. As shown in FIG. 1, the live streaming system 1 may include a server 10, a user terminal 20 and a user terminal 30 (30a, 30b . . . ). The user terminal 20 may be a livestreamer and the user terminal 30 may be a viewer. In some embodiments, the livestreamers and viewers may be referred to as the user. The server 10 may include one or a plurality of information processing devices connected via network NW. The user terminal 20 and 30 may be, for example, a portable terminal such as the smartphone, tablet, laptop PC, recorder, mobile game console, wearable device or the like, or the stationary computer such as desktop PC. The server 10, user terminal 20 and user terminal 30 may be communicably connected by any type of wire or wireless network NW.

The live streaming system 1 is involved in the livestreamer LV, the viewer AU, and APP provider (not shown), who provides the server 10. The livestreamer LV may record his/her own contents such as songs, talks, performance, game streaming or the like by his/her own user terminal 20 and upload to the server 10 and be the one who distributes contents in real time. In some embodiments, the livestreamer LV may interact with the viewer AU via the live streaming.

The APP provider may provide a platform for the contents to go on live streaming in the server 10. In some embodiments, the APP provider may be the media or manager to manage the real time communication between the livestreamer LV and viewer AU. The viewer AU may access the platform by the user terminal 30 to select and watch the contents he/she would like to watch. The viewer AU may perform operations to interact with the livestreamer, such as commenting or cheering the livestreamer, by the user terminal 30. The livestreamer, who provides the contents, may respond to the comment or cheer. The response of the livestreamer may be transmitted to the viewer AU by video and/or audio or the like. Therefore, a mutual communication among the livestreamer and viewer may be accomplished.

The “live streaming” in this specification may be referred to as the data transmission which enables the contents the livestreamer LV recorded by the user terminal 20 to be substantially reproduced and watched by the viewer AU via the user terminal 30, In some embodiments, the “live streaming” may also refer to the streaming which is accomplished by the above data transmission. The live streaming may be accomplished by the well-known live streaming technology such as HTTP Live Streaming, Common Media Application Format, Web Real-Time Communications, Real-Time Messaging Protocol, MPEG DASH or the like. The live streaming may further include the embodiment that the viewer AU may reproduce or watch the contents with specific delay while the livestreamer is recording the contents. Regarding the magnitude of the delay, it should be at least small enough to enable the livestreamer LV and the viewer AU to communicate. However, live streaming is different from so-called on-demand streaming. More specifically, the on-demand streaming may be referred to as storing all data, which records the contents, in the server and then providing the data from the server to the user at random timing according to the user's request.

The “streaming data” in this specification may be referred to as the data includes image data or voice data. More specifically, the image data (may be referred to as video data) may be generated by the image pickup feature of the user terminal 20 and 30. The voice data (may be referred to as audio data) may be generated by the audio input feature of the user terminal 20 and 30. The streaming data may be reproduced by the user terminal 20 30, so that the contents relating to users may be available for watching.

In some embodiments, during the period from the streaming data being generated by the user terminal of the livestreamer to being reproduced by the user terminal of the viewer, the processing of changing format, size or specification of the data, such as compression, extension, encoding, decoding, transcoding or the like, is predictable. Before and after this kind of processing, the contents (such as video and audio) are substantially unchanged, so it is described in the current embodiments of the present disclosure that the streaming data before being processed is the same as that after being processed. In other words, if the streaming data is generated by the user terminal of the livestreamer and reproduced by the user terminal of the viewer via the server 10, the streaming data generated by the user terminal of the livestreamer, the streaming data passed through the server 10 and the streaming data received and reproduced by the by the user terminal of the viewer are all the same streaming data.

As shown in FIG. 1, the livestreamer LV is providing the live streaming. The user terminal 20 of the livestreamer generates the streaming data by recording his/her video and/or audio, and transmits to the server 10 via the network NW. At the same time, the user terminal 20 may display the video VD on the display of the user terminal 20 to check the streaming contents of the livestreamer LV.

The viewer AU1, AU2 of the user terminal 30a, 30b, who request the platform to provide the live streaming of the livestreamer, may receive streaming data corresponding to the live streaming via the network NW and reproduce the received streaming data to display the video VD1, VD2 on the display and output the audio from a speaker or the like. The video VD1, VD2 displayed on the user terminal 30a, 30b respectively may be substantially the same as the video VD recorded by the user terminal of the livestreamer LV, and the audio outputted from the terminal 30a, 30b may also be substantially the same as the audio recorded by the user terminal of the livestreamer LV.

The recording at the user terminal 20 of the livestreamer may be simultaneous with the reproducing of the streaming data at the user terminal 30a, 30b of the viewer AU1, AU2. If a viewer AU1 inputs a comment on the contents of the livestreamer LV into the user terminal 30a, the server 10 will display the comment on the user terminal 20 of the livestreamer in real time, and also display on the user terminal 30a, 30b of the viewer AU1, AU2 respectively. If the livestreamer LV responds to the comment, the response may be outputted as the text, image, video or audio from the terminal 30a, 30b of the viewer AU1, AU2, so that the communication of the livestreamer LV and viewer LV may be realized. Therefore, the live streaming system may realize the live streaming of two-way communication.

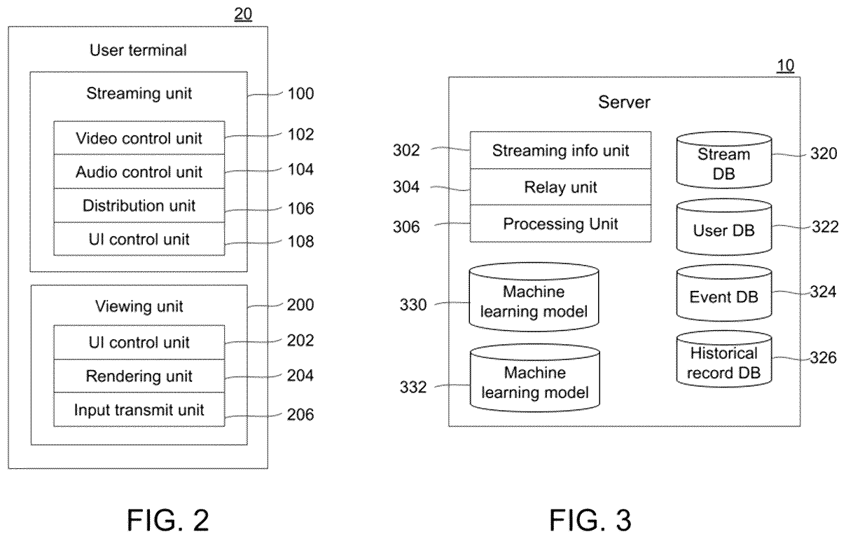

FIG. 2 is a block diagram showing a function and configuration of the user terminal 20 in FIG. 1 according to the embodiment of the present disclosure. The user terminal 30 has the similar function and configuration of the user terminal 20. The blocks depicted in the block diagram of this specification are implemented in hardware such as devices like a CPU of a computer or mechanical components, and in software such as a computer program depicts functional blocks implemented by the cooperation of these elements. Therefore, it will be understood by those skilled in the art that the functional blocks may be implemented in a variety of manners by a combination of hardware and software.

The livestreamer LV and viewer AU may download and install the live streaming application (live streaming APP) of the present disclosure to the user terminal 20 and 30 from the download site via network NW. Or the live streaming APP may be pre-installed in the user terminal 20 and 30. By the execution of the live streaming by the user terminal 20 and 30, the user terminals 20 and 30 may communicate with the server 10 via the network NW to realize a plurality of functions. The functions realized by the execution of the live streaming APP by the user terminal 20 and 30 (More specifically, the processor such as CPU) is described below as the functions of the user terminal 20 and 30. These functions are basically the functions that the live streaming APP makes the user terminals 20 and 30 realize. In some embodiments, these functions may also be realized by transmitting from the server 10 to the web browser of the user terminal 20 and 30 via network NW and be executed by the computer program of the web browser. The computer program may be written in the programming language such as HTML (Hyper Text Markup Language) or the like.

The user terminal 20 includes streaming unit 100 and viewing unit 200. In some embodiments, the streaming unit 100 is configured to record the audio and/or video data of the user and generate streaming data to transmit to the server 10. The viewing unit 200 is configured to receive and reproduce streaming data from server 10. In some embodiments, a user may activate the streaming unit 100 when broadcasting or activate the viewing unit 200 when watching streaming respectively. In some embodiments, the user terminal who is activating the streaming unit 100 may be referred to as an livestreamer or be referred to as the user terminal which generates the streaming data. The user terminal who is activating the viewing unit 200 may be referred to as an viewer or be referred to as the user terminal which reproduces the streaming data.

The streaming unit 100 may include video control unit 102, audio control unit 104, distribution unit 106 and UI control unit 108. The video control unit 102 may be connected to a camera (not shown) and the video is controlled by the camera. The video control unit 102 may obtain the video data from the camera. The audio control unit 104 may be connected to a microphone (not shown) and the audio is controlled by the microphone. The audio control unit 104 may obtain the audio data from the microphone.

The distribution unit 106 receives streaming data, which includes video data from the video control unit 102 and audio data from the audio control unit 104, and transmits to the server 10 via network NW. In some embodiments, the distribution unit 106 transmits the streaming data in real-time. In other words, the generation of the streaming data from the video control unit 102 and audio control unit 104, and the distribution of the distribution unit 106 is performed simultaneously.

UI control unit 108 controls the UI for the livestreamer. The UI control unit 108 is connected to a display (not shown) and is configured to generate the streaming data to whom the distribution unit 106 transmits, reproduces and displays the streaming data on the display. The UI control unit 108 shows the object for operating or the object for instruction-receiving on the display and is configured to receive the tap input from the livestreamer.

The viewing unit 200 may include UI control unit 202, rendering unit 204 and input transmit unit 206. The viewing unit 200 is configured to receive streaming data from server 10 via network NW. The UI control unit 202 controls the UI for the viewer. The UI control unit 202 is connected to a display (not shown) and/or speaker (not shown) and is configured to display the video on the display and output the audio from the speaker by reproducing the streaming data. In some embodiments, Outputting the video on the display and audio from the speaker may be referred to as “reproducing the streaming data”. The UI control unit 202 may be connected to an input unit such as touch panel, keyboard or display or the like to obtain input from the users.

The rendering unit 204 may be configured to render the streaming data from the server 10 and the frame image. The frame image may include user interface objects for receiving input from the user, the comments inputted by the viewers and the data received from the server 10. The input transmit unit 206 is configured to receive the user input from the UI control unit 202 and transmit to the server 10 via the network NW.

In some embodiments, the user input may be clicking an object on the screen of the user terminal such as selecting a live stream, entering a comment, sending a gift, following or unfollowing an user, voting in an event, gaming or the like. For example, the input transmit unit 206 may generate gift information and transmit to server 10 via the internet NW if the user terminal of the viewer clicks a gift object on the screen in order to send a gift to the livestreamer.

FIG. 3 is a schematic block diagram of the server 10 according to some embodiments of the subject application. The server 10 may include streaming info unit 302, relay unit 304, processing unit 306, stream DB 320, user DB 322, event DB 324, historical record DB 326, machine learning models 330 such as content-based model or behavior-based model and machine learning models 332 such as language model or the like.

The streaming info unit 302 receives the request of live streaming from the user terminal 20 of the livestreamer via the network NW. Once receiving the request, the streaming info unit 302 registers the information of the live streaming on the stream DB 320. In some embodiments, the information of the live streaming may be the stream ID of the live streaming and/or the livestreamer ID of the livestreamer corresponding to the live streaming.

Once receiving the request of providing the information of the live streaming from the viewing unit 200 of the user terminal 30 from the viewer via the network NW, the streaming info unit 302 refers to the stream DB 320 and generates a list of the available live streaming.

The streaming info unit 302 then transmits the list to the user terminal 30 via the network NW. The UI control unit 202 of the user terminal 30 generates a live streaming selection screen according to the list and displays the list on the display of the user terminal 30. Once the input transmit unit 206 of the user terminal 30 receives the selection of the live streaming from the viewer on the live streaming selection screen, it generates the streaming request including the stream ID of the selected live streaming and transmits to the server 10 via the network. The streaming info unit 302 may start to provide the live streaming, which is specified by the stream ID in the streaming request, to the user terminal 30. The streaming info unit 302 may update the stream DB 320 to add the viewer's viewer ID of the user terminal 30 to the livestreamer ID of the stream ID.

The relay unit 304 may relay the transmission of the live streaming from the user terminal 20 of the livestreamer to the user terminal 30 of the viewer in the live streaming started by the streaming info unit 302. The relay unit 304 may receive the signal, which indicates the user input from the viewer, from the input transmit unit 206 while the streaming data is reproducing. The signal indicating the user input may be the object-designated signal which indicates the designation of the object shown on the display of the user terminal 30. The object-designated signal may include the viewer ID of the viewer, the livestreamer ID of the livestreamer, who delivers the live streaming the viewer is viewing, and object ID specified by the object. If the object is a gift or the like, the object ID may be the gift ID or the like. Similarly, the relay unit 304 may receive the signal indicating the user input of the livestreamer, for example the object-designated signal, from the streaming unit 100 of the user terminal 20 while the streaming data is reproducing.

The processing unit 306 is configured to process requests in response to operations from a user terminal of a user. For example, the user may click on the event list button to make a request on the event list. Once the relay unit 304 receives the request, the processing unit 306 may refer to the event DB 324 and retrieve the event list, and the processing unit 306 and the relay unit 304 may further transmit the event list to the user terminal of the user.

In some embodiments, the processing unit 306 may further retrieve data from databases and feed the data into a machine learning model for recommendation, summary, response or the like. In some embodiments, the machine learning model may be an internal-trained model or a model provided by a third-party service provider. In some embodiments, the machine learning model for recommendation may be realized by a content-based model, behavior-based model such as Matrix Factorization or the like.

In some embodiments, the machine learning model for summary, response or the like may be realized by the Language Model or the like. In some embodiments, the machine learning model may be an AI Chatbot such as ChatGPT or other LLM (large language model) or the like. In some embodiments, the machine learning technique may be realized by any possible and available model according to the practical need.

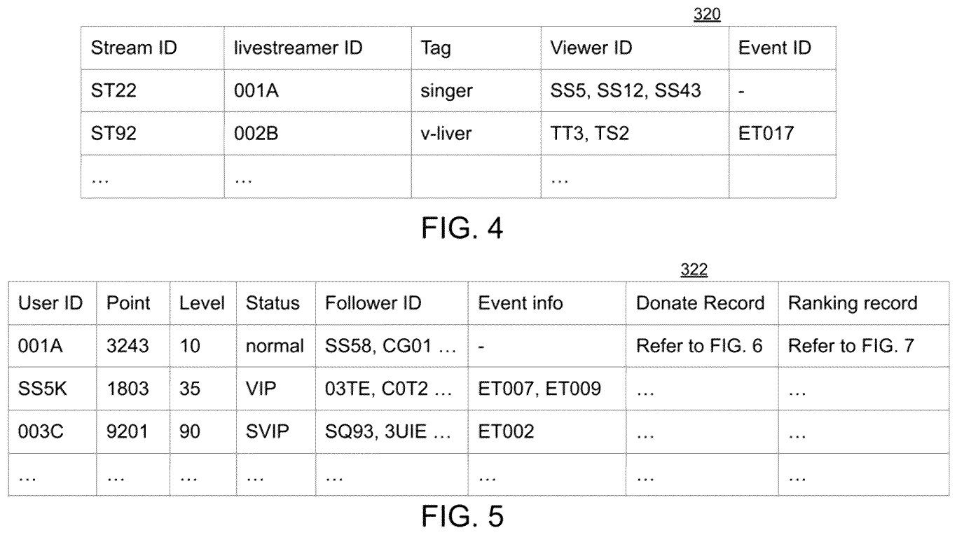

FIG. 4 shows an exemplary data structure of the stream DB 320 of FIG. 3. The stream DB 320 holds information regarding a live stream currently taking place. The stream DB 320 stores a stream ID for identifying a live-stream on a live distribution platform provided by the live-streaming system 1, a livestreamer ID for identifying the livestreamer who provides the live-stream, a tag for identifying category or topic of the stream, a viewer ID for identifying a viewer of the live-stream, and an event ID for identifying event in the stream, in association with each other.

In some embodiments, the tag may be set manually or automatically by machine learning model or the like. In some embodiments, the event ID may be empty if the livestreamer in the stream is not participating in an event. The livestreamer may select an event before or during the live streaming to determine whether to participate in an event or not.

FIG. 5 shows an exemplary data structure of the user DB 322 of FIG. 3. The user DB 322 holds information regarding users. The user DB 322 stores a user ID for identifying a user, points for identifying the points the user accumulates, level for identifying the level of the user and status for identifying the status of the user in association with each other. The point is the electronic value circulated within the live-streaming platform. The level may be an indicator of the amount of user activity or engagement on the live streaming platform. The status may be an identity or membership status of the user on the live streaming platform. In some embodiments, the event may also be recommended according to the information of the user in user DB 322 such as level, status or the like.

In some embodiments, the point may further include detailed information of the points. The detailed information may be the points received from other users or transmitted to other users. The detailed information may also include a combination of the receiving points, for example, the points received by purchasing from the APP provider, the points received from viewer's donation, the points received freely from the APP provider or the like. In some embodiments, the points received from different ways may be combined for calculation or calculated separately. In some embodiments, the way for calculating and displaying the points may be determined flexibly according to the practical need.

In some embodiments, the user DB 322 may store the follower ID of the user. The follower may be the other users who follow the user and the follower ID may be the user ID of the other users. Here, following a user may refer to setting the user as a related user such as friends, idols, fans or the like, so that the other users may receive notifications related to the user when the user is streaming, posting or the like. In some embodiments, the follower may be more loyal to the user and willing to watch the user's stream or donate gifts to the user or the like.

In some embodiments, the user DB 322 may further store interaction value on each follower ID, which shows the degree of interaction between the user and the follower. The interaction may be watching streams, messaging, donating, gifting, commenting or the like. In some embodiments, the user DB 322 may also store the last-login time of the follower, which may be used to determine whether the user is an active user. In some embodiments, the user DB 322 may store the followee ID of the user, which means that the other users who are followed by the user. In some embodiments, the users who mutually follow each other may be more loyal to each other.

In some embodiments, the user DB 322 may store the event info of the user. The event info may be the event information the user used to participate in or is now participating in. In some embodiments, the event information may include the event ID, number of events the user used to participate in, the number of winning or losing the event, the rewards received from the event or the like. In some embodiments, the user may be identified as a beginner or experienced user in the event according to the event information.

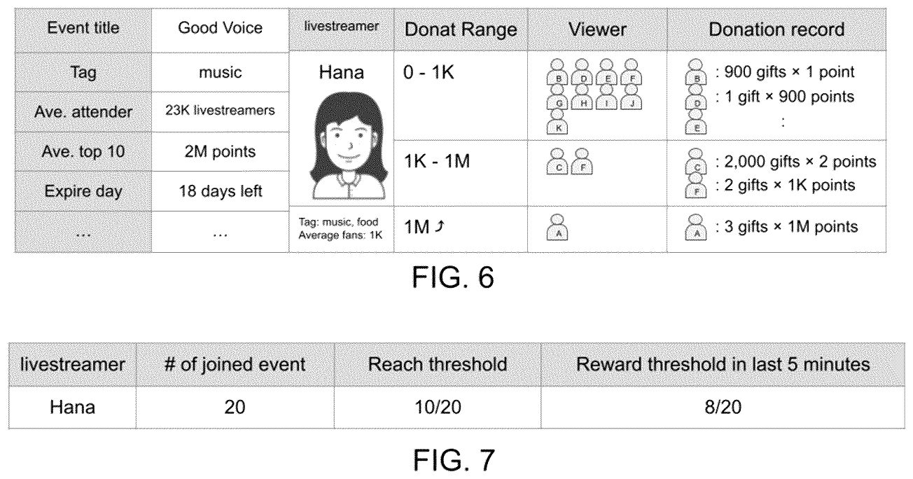

In some embodiments, the user DB 322 may also store the donation record of the user in the live streaming platform. The donation record may be the donation the user received or sent during the event or the like. FIG. 6 shows an exemplary data structure of the donation record in the user DB 322. As shown in FIG. 6, the donation record may store the donation record of the viewers to the livestreamer in an event. More specifically, the donation record may show the total donation of each viewer and the combination of the donation such as the number of gifts and the gifts' corresponding points.

In some embodiments, the donation record may classify the user into different donation ranges for analysis. For example, the donation range may be divided into “0-1K”, “1K-1M” and “over 1M”, and here the 1K stands for one thousand and 1M stands for one million. Each viewer may be classified according to their donation as shown in FIG. 6. In some embodiments, the donation record may also include the information of the livestreamer and the event for analysis.

In some embodiments, the user DB 322 may also store the ranking record of the user in the events. FIG. 7 shows an exemplary data structure of the winning record in the user DB 322. As shown in FIG. 7, the winning record may store the number of events the livestreamer participates in, the number of events the livestreamer wins or reaches the reward threshold and also the number of events the livestreamer reaches the reward threshold during the last moment before the end of the event. In some embodiments, the last moment may be the last five minutes or the like.

The last moment before the end of the event is always considered the most thrilling moment in an event. The viewers always gather together with the livestreamer to support the livestreamer for the event. The viewers donate event gifts to the livestreamer and wait until the end of the event in order to let their favorite livestreamer win or achieve reward threshold in an event. Especially, the livestreamers who always win at the last moment may be considered as a competitive livestreamer in the event. The reason is that the livestreamer may have much more loyal viewers who are generous in donations or the like. Therefore, the winning record, especially the winning rate in the last minute, may be an index to determine whether the livestreamer has a high likelihood of winning in an event.

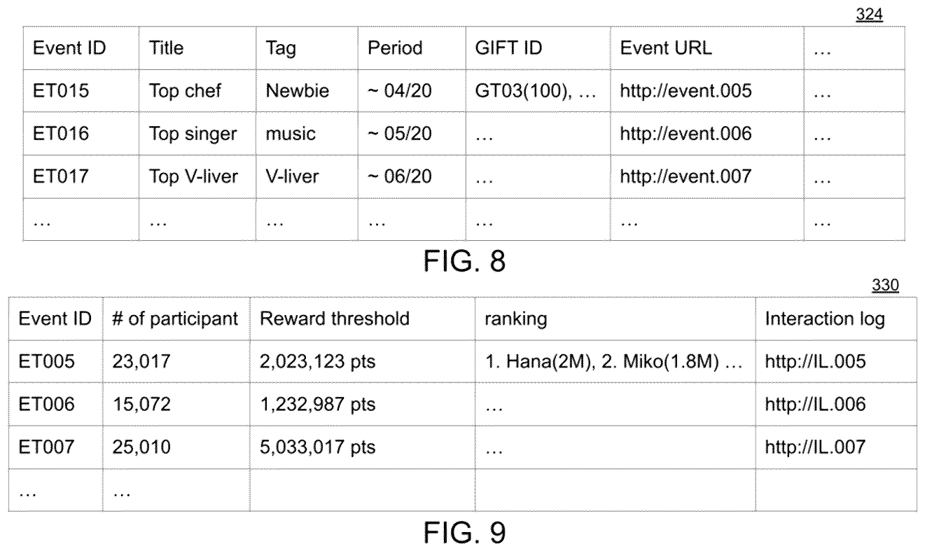

FIG. 8 shows an exemplary data structure of the event DB 324 of FIG. 3. The event DB 322 holds information regarding events on a live distribution platform provided by the live-streaming system 1. The event DB 324 stores an event ID for identifying an event, title for identifying title of the event, tag for identifying category or topic of the events, the period for identifying the starting time and end time of the event, the gift ID for identifying the gift in an event, the event URL for identifying the location of the event page, in association with each other.

In some embodiments, the event DB 324 may store the information of events which are currently ongoing or expired. In some embodiments, a separated database may be provided for storing the historical event data. FIG. 9 shows an exemplary data structure of the historical record DB 326 of FIG. 3. The historical record DB 326 holds information regarding historical event data on a live distribution platform provided by the live-streaming system 1.

The historical record DB 326 stores an event ID for identifying an historical event, number of participant for identifying the number of participant in the event, reward threshold for identifying the threshold for receiving the reward, ranking for identifying the ranking of participant in the event, interaction log for identifying the interaction between livestreamers and viewers in the event, in association with each other. In some embodiments, the expired event may be moved to the historical record DB 326 for analysis, so the historical record DB 326 may also include the same information stored in the event DB 324.

Here, the “reward threshold” may refer to the condition to obtain reward in an event. For example, the event rules may state that if the livestreamer accumulates more than 1M points, they will obtain virtual items. Here, the 1M points may be referred to as the reward threshold. The event may also state that if the livestreamer is ranked at top 10 in the leaderboard, they will obtain the chance to perform or exposure to media. If the receiving points of the livestreamer at 10th place is 0.5M points, then the 0.5M points may be referred to as the reward threshold.

Here, the “interaction log” may be the data log in the live streaming platform during the period of the event. In some embodiments, the data log may include the operation from the user, the time information, the location information or other related information. For example, the data log may include that the livestreamer sang a song at a specific time point, the viewer donated five gifts with 2,000 points for each gift or the like. In some embodiments, the interaction log may also be arranged as a table or visualized as a chart for analysis.

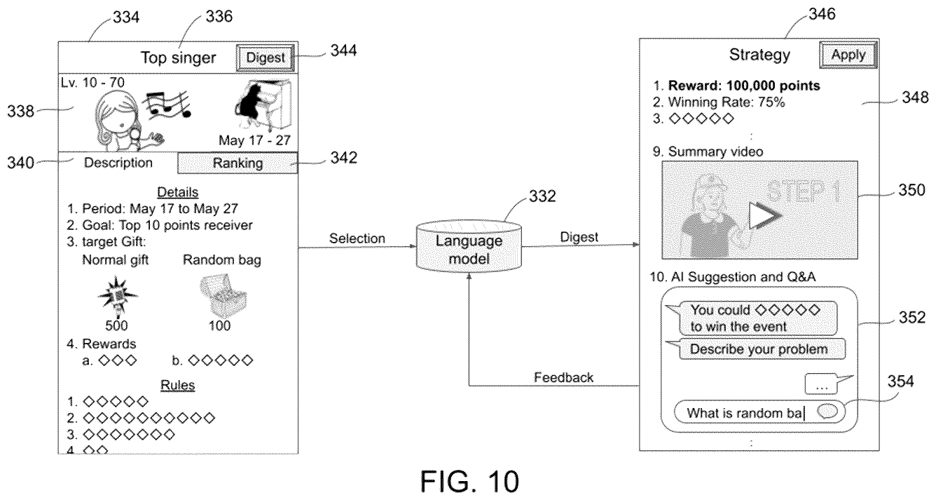

FIG. 10-FIG. 12 are exemplary functional configurations of the live streaming system 1 according to some embodiments of subject application. As stated above, the APP provider may provide a plurality of events for the livestreamer to select and participate in to increase the interaction between livestreamers and viewers. The left side of FIG. 10 shows an exemplary event page 334. The livestreamer may click a button on the screen to request the event list. Once the livestreamer selects an event to check the description of the event, the corresponding event page 334 may be shown on the user terminal.

As shown in FIG. 10, the event page 334 may include the title 336, banner 338, description 340 and ranking 342. The banner 338 may be an image or video with text or the like to represent the event. In some embodiments, the banner 338 may include information for the user to identify whether he or she is suitable or qualified for the event. For example, the banner 338 may include labels with “female user only” or “For level 10-70” or the like for the reference. In some embodiments, the description 340 may include the detailed information about the event such as the period, goal, gift to be collected, reward, rules and other relevant details. If the description is overly lengthy or the rules are excessively complex, it may deter the livestreamer from participating in an event.

In some embodiments, the event page 334 may further include a digest button 344. The digest button 344 is configured to digest the description of the event for the livestreamer to easily understand and catch the key point of the event. As shown in FIG. 10, once the digest button is clicked, the processing unit 306 may feed information of the event and/or the livestreamer to a machine learning model. Here, the language model 332 is used as an example for explanation. In some embodiments, the language model may be any possible or available model such as ChatGPT or the like. In some embodiments, the machine language models may infer the possible output according to the input and the procedure of digesting may refer to providing users with the inference from the models.

The language model 332 may generate a strategy page 346 for the event according to the information of the event and/or the livestreamer. For example, the language model 332 may generate a summary 348 including key points in the event for the livestreamer. In some embodiments, the layout of the summary 348 may be displayed in conversational sentences or a bullet point format. In some embodiments, important information in the summary 348 may also be highlighted to let the livestreamer understand. In some embodiments, the event may include different rounds and the users who pass the first round may participate in the next or final round. In some embodiments, the strategy page 346 may include the summary 348 of the current round only so the length of the contents may be reduced for the user to easily understand.

In some embodiments, the strategy page 346 may further include a video object 350. The video object may also be generated by AI, machine learning models or video editing software used for text-to-video conversion. More specifically, the processing unit 306 may feed the description of events into the language model 322 or the like to generate summary and further generate the video from the summary by AI or video editing software or the like. In some embodiments, the event page 334 or the strategy page 346 may include bookmarks for the user to get access to the desired information. In some embodiments, the event page 334 or the strategy page 346 may also include a share button for the user to share the information with the other users. According to the embodiments, it may motivate the livestreamer to understand and participate in the event.

In some embodiments, the strategy page 346 may further include an AI Chatbot 352. The AI Chatbot 352 may generate a summary of the event and provide suggestions in a conversational form. According to the embodiments, it may motivate the livestreamer to understand and participate in the event. Moreover, the AI Chatbot 352 may also include the communication tool 354, such as input field or the virtual keyboard, for the livestreamer to key in questions about the event. Once the livestreamer inputs a feedback such as a question, the processing unit 306 may further feed the feedback back to the language model 332 and generate response for the steamer. In some embodiments, the strategy page 346 may include any possible information, such as mini-game or the like, to assist the livestreamer in better understanding the event.

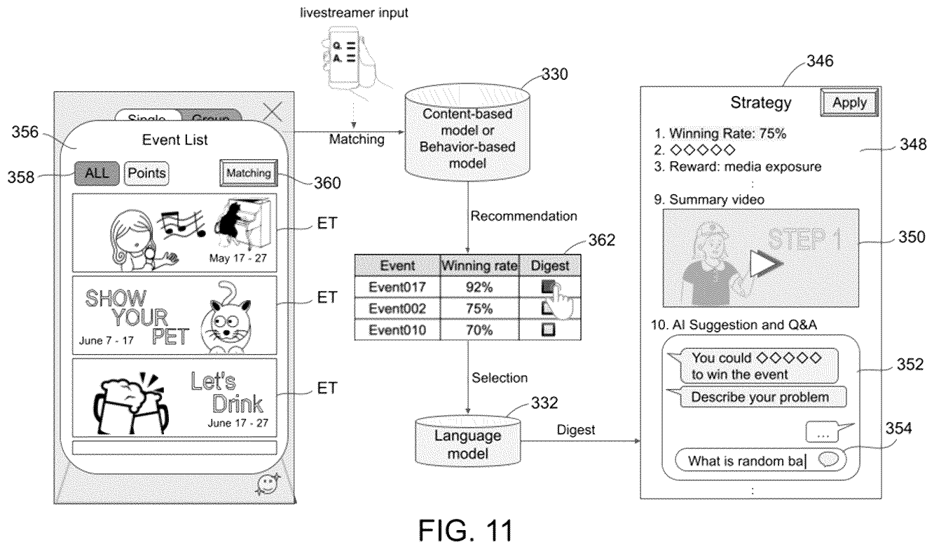

The left side of FIG. 11 shows an exemplary event list page 356. As shown in FIG. 11, the event list page 356 may include a plurality of events ET and category tab 358. The events ET may be the currently ongoing events in the live streaming platform. The category tab 358 may include buttons with category for the livestreamer to switch to the interested category for selection. For example, the category may be sorted by event type such as music or talk show, or sorted by reward such as points or media exposure, or sorted by time such as starting time or ending time or remaining time of the event or the like for the user to switch. According to the embodiments, the user may select the appropriate event.

In some embodiments, the event list page 356 may further include a matching button 360. The matching button 344 is configured to match the event with the livestreamer according to the information of the event and the livestreamer. In some embodiments, the matching may be performed based on the similarity between the information of the event and livestreamer. In some embodiments, the match may also be performed based on the winning rate of the livestreamer on the event.

Here, the “winning rate” may refer to the livestreamer's possibility of winning or achieving reward in the event or the like. The winning rate may be calculated based on the similarity between the information of the event and livestreamer. Moreover, the winning rate may also be calculated based on the positive, neutral or negative factor according to the information of the event and livestreamer. The factors may be pre-determined and fed into the machine learning model, or trained and learned by the machine learning model. For example, if the livestreamer has a high percentage of viewers who donate gifts with high points, the livestreamer tends to win in an event. The reason is that viewers with donation of high points helps the livestreamer to achieve the reward threshold compared with viewers with donation of low points.

Moreover, if the livestreamer's winning rate in the last minute is relatively high, it may show that the livestreamer has loyal viewers who are generous in donations. Therefore, it may also be a positive factor to determine the winning rate. In some embodiments, the one-way follower or mutual follower may show the loyalty of the viewer and may also contribute to the winning rate. For example, the number of viewers who follow the livestreamer mutually may be a positive or negative factor. Moreover, the login-time of the viewers may also be considered since it may be a negative factor if the viewer is an inactive user in the platform. In some embodiments, any possible factors related to the livestreamer and the event may be considered according to the practical need.

The winning rate may also be determined by machine learning models. For example, the information of events and livestreamer may be retrieved and fed into the machine learning model 330 for recommendations such as content-based model or behavior-based model or the like. Here, the information of events may include the currently on-going event from event DB 324 and also the historical event data from the historical record DB. In some embodiments, the event may be a one-time event, period-limited event, periodic or non-periodic event. If the event is a periodic event, the historical event data of the event may be taken as a reference for analysis.

As stated above, the information of events and livestreamer may be classified and tagged as positive, neutral or negative factors for the machine learning model to learn and calculate the livestreamer's winning rate in the event. In some embodiments, the factor may further be classified into primary factor or secondary factor. Additionally, each factor may influence the score increments or decrements and may also lead to adjustments in weightage. For example, the donation record may be a primary factor and the following relationship may be a secondary factor. If the viewer often donates gifts worth over 1,000 points at once, the winning rate may increase by 1% or the like. However, if the viewer is not a follower of the livestreamer, the 1% score increase may be weighted down to 0.8%. In some embodiments, the process for determining the winning rate may be determined flexibly according to the machine learning model or the like.

In some embodiments, the server 10 may also receive input from the user to perform the matching between the event and the livestreamer. For example, the processing unit 306 may generate a feedback form or AI Chatbot for receiving the input from the livestreamer. The livestreamer may provide their requests or preferences for the event. For example, the rewards in the event may be the points, virtual item, performance chance, media exposure or the like. The livestreamer may provide feedback by showing interests in the reward section and especially for the reward of media exposure or the like. The processing unit 306 may further filter the event according to the livestreamer's request, preference or the like.

As shown in FIG. 11, the information of event and livestreamer and/or the livestreamer input may be fed into the machine learning model 330 such as content-based model or behavior-based model 330 for recommendation. In some embodiments, output of the content-based model or behavior-based model 330 may be an event recommendation list 362 as shown in FIG. 11. The event recommendation list 362 may include recommended event information such as event ID or the like. The recommended event may be listed according to the winning rate or similarity, and be arranged in descending order or the like. In some embodiments, a digest button corresponding to each recommended event may also be attached for the livestreamer's reference.

Once a digest button corresponding to an event is clicked, the processing unit 306 may feed information of the event to the language model 332 and the language model 332 may generate the strategy page 346 for the event according to the information of the event or the like. The way for generating strategy page 346 from the event via language model 332 is the same as that described above so it will not be further elaborated here.

In some embodiments, the order or format of the contents on the strategy page 346 may be determined flexibly according to the livestreamer's request, preference or the like. For example, the livestreamer may show interest in the reward or winning rate, and the reward or winning rate may be listed in the first line, displayed in bold or with a yellow background or the like. In some embodiments, the order or format of the summary 348, video object 350, AI Chatbot 352 or the like may be rearranged dynamically and flexibly according to the practical need.

In some embodiments, the livestreamer may participate in an event and start broadcasting. Once the livestreamer selects an event and starts the live streaming to interact with the viewer, the processing unit 306 may provide the livestreamer with a hint message in real-time during the event. The processing unit 306 may retrieve real-time event data or historical event data from databases and feed them into a machine learning model such as language model 332 to guide the livestreamer in the event.

In some embodiments, the processing unit 306 may determine an exemplary event data according to the similarity between the events or the like. For example, if the livestreamer is participating in the event017 and the event017 is a periodic event, the processing unit 306 may retrieve the historical data of the event017 as reference. The processing unit 306 may also retrieve the event data of a historical event similar to the event0017, or retrieve the real-time event data of the event017. The processing unit 306 may further retrieve the event data such as the information of the ranking record and further retrieve the interaction log of the top one livestreamer with the viewers for analysis.

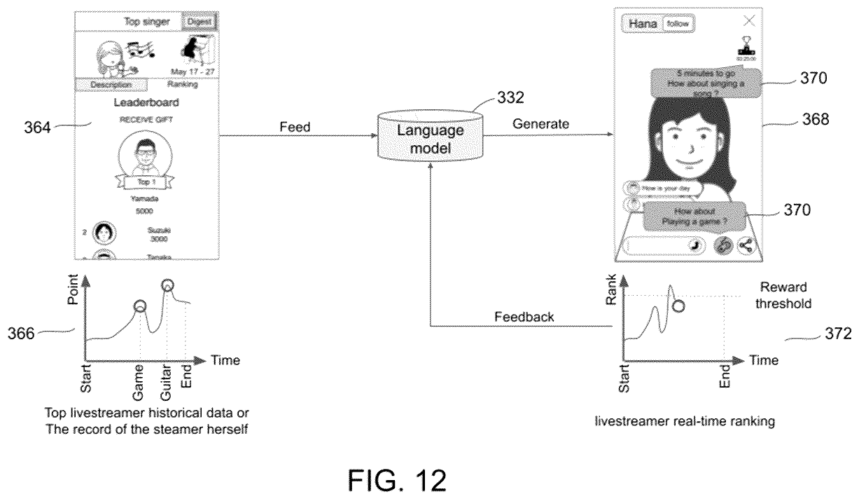

An exemplary ranking information 364 and interaction log 366 is shown in FIG. 12. The processing unit 306 may retrieve the interaction log 366 of the top one livestreamer from the ranking information 364. In some embodiments, the interaction log 366 may include the relationship of the time and receiving points during the event. In some embodiments, specific interaction information may also be reflected on the interaction log 366. For example, it may show the interaction such as “livestreamer playing a game”, “livestreamer playing a guitar”, “viewer or server 10 send lucky bag” or the like with respect to the time and receiving points.

In some embodiments, processing unit 306 may feed the information of event data into a machine learning model such as the language model 332 and generate real-time hint messages 370 for the livestreamer. FIG. 12 also shows an exemplary screen 368 with exemplary hint messages 370 for reference. As shown in FIG. 12, the hint messages 370 may be popped up on the screen 368 of the livestreamer to guide the livestreamer in the event. In some embodiments, the format of hint messages 370 may be any possible object that could guide the livestreamer to understand the event and increase the possibility of winning in the event. In some embodiments, the hint messages 370 may be text, image, video, AI assistance or the like. In some embodiments, the hint messages 370 for the livestreamers or viewers may further include the remaining time of the event, current ranking, the points behind the other users, or the donation combination of the livestreamer or the like.

In some embodiments, the processing unit 306 may monitor the situation of the streaming room. For example, the processing unit 306 may monitor the status 372 of receiving points or rank with respect to the time during the period of the event. The status 372 may include, for example, the rank of the livestreamer with respect to the time, the reward threshold, the end time of the event or the like. The processing unit 306 may monitor the status 372 and feedback back to the language model 332. The language model 332 may further generate hint messages 370 according to the feedback to help the livestreamer achieve the reward threshold or the like.

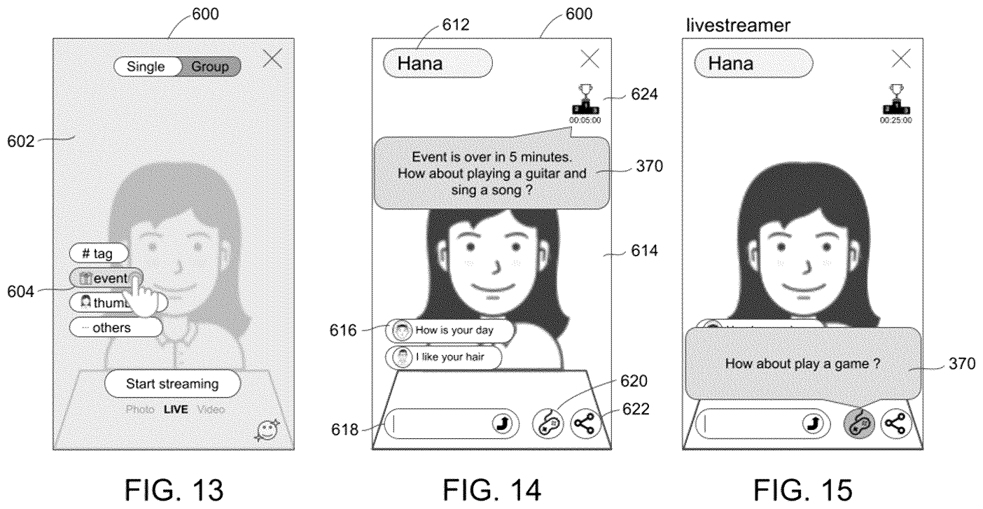

FIG. 13-FIG. 17 are exemplary screen images of a live-streaming room screen 600 shown on the display of the livestreamer user terminal 20 or the viewer user terminal 30. FIG. 13 shows an exemplary streaming pre-setting page 602 for the livestreamer to set parameters for the streaming. The pre-setting page 602 may include an event tab 604 for livestreamers to select and participate in an event. Once the livestreamer clicks on the event tab 604, the event list page 356 in FIG. 11 may be displayed for the livestreamer to select an event. In some embodiments, the event list page 356 may also be requested during or out of live streaming or the like.

Once the livestreamer selects an event and starts a live streaming, a live streaming room screen 600 of the livestreamer may be shown on the display. The live streaming room screen 600 may include a livestreamer info object 612, livestreamer image 614, message zone 616, message input box 618, game object 620, sharing object 622, event object 624 or the like. The event object 624 may show the event the livestreamer is currently participating in and also the remaining time of the event, the current rank or the like.

In some embodiments, the processing unit 306 may provide the livestreamer with hint message 370 according to the historical event data via the language model 332. As shown in FIG. 12 as an example, the receiving points of a livestreamer Yamada increased while playing a game with the viewers and increased again when he played the guitar in the last five minutes before the end of the event according to the interaction log 366. The language model 332 may generate hint messages 370 according to the interaction log 366. Therefore, as shown in FIG. 14 and FIG. 15, a hint message 370 of “Event is over in 5 minutes. How about playing a guitar and singing a song?” or “How about playing a game?” may be transmitted and displayed to the livestreamer's terminal to guide the livestreamer in the event.

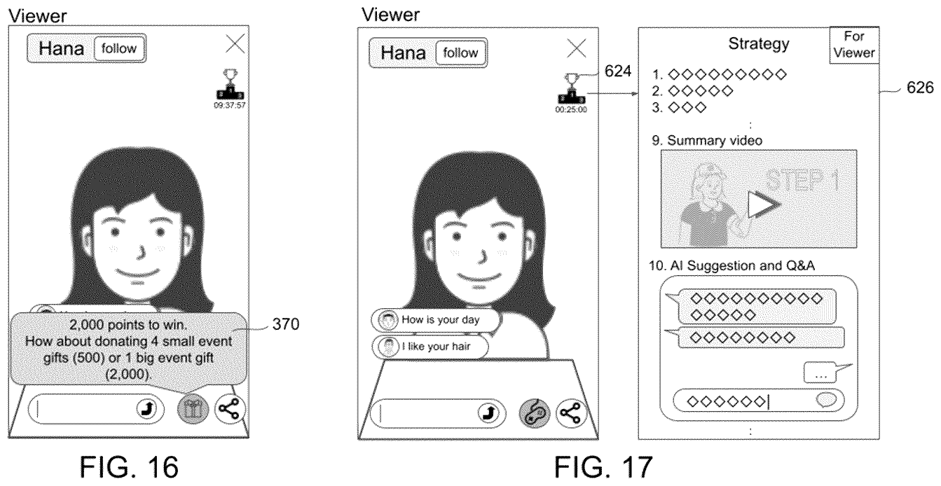

In some embodiments, the machine learning model for the events may also be applied to the viewer side. For example, if the livestreamer needs 2,000 points to win or meet the reward threshold, a hint message 370 of “2,000 points to win. How about donating 4 small event gifts (500) or 1 big event gift (2,000).” may be displayed to guide the viewer for helping the livestreamer as shown in FIG. 16. In some embodiments, the hint message 370 displayed in the viewers' terminal may include other information to help the viewer understand the event.

In some embodiments, a strategy page 626 for the viewer may also be generated to guide the viewer to help the livestreamer. In some embodiments, the viewer may click the event object 624 to receive event description and current ranking. Moreover, the viewer may also receive the strategy page 626 via the event object 624 as shown in FIG. 17. The strategy understand the event and help the livestreamer. The strategy page 626 for the viewer may also be generated similar to that in strategy page 346 but from the viewers' point of view so it will not be further elaborated here.

The strategy page 626 may further include the strategy for the viewer and the strategy may also be generated by the language model 332. For example, the gift in an event may include a normal gift, or random bag or the like. The normal gift may be sent to the livestreamer with a specific number of points, and the livestreamer may receive the specific point from the viewer. The random bag may be sent to the livestreamer with a specific number of points and the livestreamer may receive points with a possibility of it being higher, equal to, or lower than the specific points. The strategy 626 or the hint messages 370 may provide the viewer with the expectation value of the random bag to help the viewer determine whether to send the normal gift, random bag or the like.

Moreover, the gift in an event may include a combo gift, combination gift or the like. The livestreamer may receive extra points if the viewer sends a specific number of combo gifts or sends a specific combination of gifts. The strategy 626 or the hint messages 370 may also provide the viewer with the information of the gifts with extra points to help the viewer understand and donate to their favorite livestreamer in a more efficient way. In some embodiments, the contents and format of the strategy page 626 and hint messages 370 may also be designed flexibly according to the practical need.

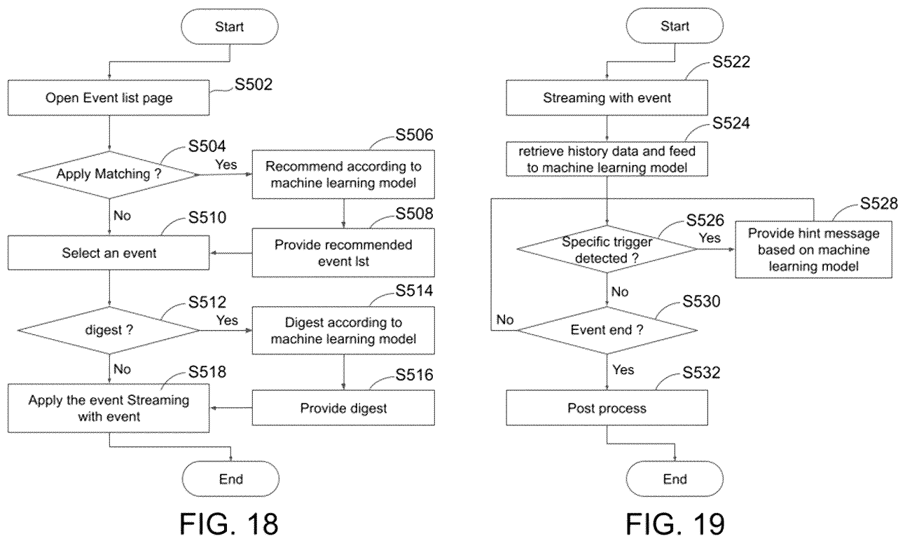

FIG. 18 is a flowchart showing steps of an operation of the configuration of the live streaming system 1 according to some embodiments of subject application. The livestreamer may open the event list page to check and select an event (S502). If the livestreamer has difficulty understanding and selecting an event, a matching between the livestreamer and events may be applied by clicking the matching button. If a matching is applied (Yes in S504), the processing unit 306 may recommend the livestreamer appropriate events according to the machine learning model (S506). The processing unit 306 may further provide the recommended event list to the livestreamer's user terminal (S508).

The livestreamer may select an event from the recommended event list (S510). In some embodiments, if the matching is not applied (No in S504), the livestreamer may directly select an event from the event list page (S510). Once an event is selected, the livestreamer may determine whether to digest the event (S512). If a digest button is clicked (Yes in S512), the processing unit 306 may digest the information of the event according to the machine learning model (S514). The processing unit 306 may further provide the digest to the livestreamer's user terminal (S516). The livestreamer may further apply the event and start the live streaming with the selected event (S518). In some embodiments, if the digest button is not clicked (No in S512), the livestreamer may still apply the event and start the live streaming with the selected event (S518).

FIG. 19 is a flowchart showing steps of an operation of the configuration of the live streaming system 1 according to some embodiments of subject application. Once the livestreamer starts the live streaming with the selected event (S522), the processing unit 306 may retrieve the historical or real-time event data, and feed them into the machine learning model (S524) to generate real-time hint messages for the livestreamer.

During the event, the processing unit 306 may keep monitoring the status of the live streaming room and provide hint messages according to the status. The status may be a specific time point such as the last five minutes before the end of the event. The status may also be a specific status such as the receiving point of the livestreamer is decreasing or the like. This kind of information may be considered as a trigger for the processing unit 306 to provide hint messages according to the machine learning model.

In some embodiments, the processing unit 306 may detect whether there is a specific trigger from the status of the live streaming room (S526). If a specific trigger is detected (Yes in S526), the processing unit 306 may provide a hint message based on the machine learning model (S528) and keep detecting another specific trigger (S526). If there is no specific trigger detected (No in S526), the processing unit 306 may check whether the event has ended or not (S530). If the event is still on-going (No in S530), the processing unit 306 may keep monitoring and detecting the specific trigger (S526). If the event has ended (Yes in S530), the processing unit 306 may perform the post-event process such as closing the event and calculating the leaderboard or the like (S532).

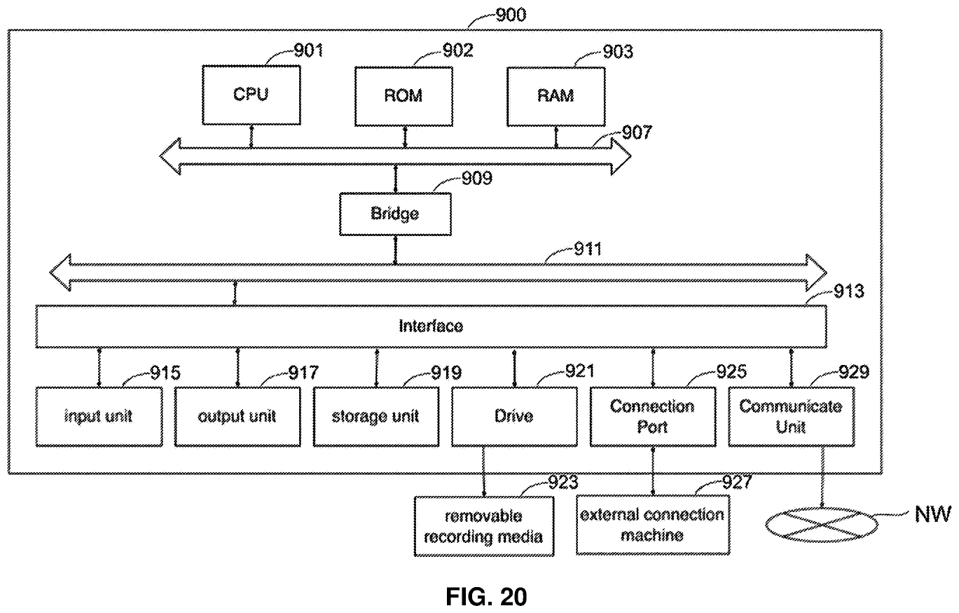

FIG. 20 is a schematic block diagram of computer hardware for carrying out a system configuration and processing according to some embodiments of subject application. The information processing device 900 in FIG. 20 is, for example, is configured to realize the server 10 and the user terminal 20, 30 respectively according to some embodiments of subject application.

The information processing device 900 includes a CPU 901, read only memory (ROM) 903, and random-access memory (RAM) 905. In addition, the information processing device 900 may include a host bus 907, a bridge 909, an external bus 911, an interface 913, an input unit 915, an output unit 917, a storage unit 919, a drive 921, a connection port 925, and a communication unit 929. The information processing device 900 may include imaging devices (not shown) such as cameras or the like. The information processing device 900 may include a processing circuit such as a digital signal processor (DSP) or an application-specific integrated circuit (ASIC), instead of or in addition to the CPU 901.

The CPU 901 functions as an arithmetic processing device and a control device, and controls the overall operation or a part of the operation of the information processing device 900 according to various programs recorded in the ROM 903, the RAM 905, the storage unit 919, or a removable recording medium 923. For example, the CPU 901 controls overall operations of respective function units included in the server 10 and the user terminal 20 and 30 of the above-described embodiment. The ROM 903 stores programs, operation parameters, and the like used by the CPU 901. The RAM 905 transiently stores programs used when the CPU 901 is executed, and parameters that change as appropriate when executing such programs. The CPU 901, the ROM 903, and the RAM 905 are connected with each other via the host bus 907 configured from an internal bus such as a CPU bus or the like. The host bus 907 is connected to the external bus 911 such as a Peripheral Component Interconnect/Interface (PCI) bus via the bridge 909.

The input unit 915 is a device operated by a user such as a mouse, a keyboard, a touchscreen, a button, a switch, and a lever. The input unit 915 may be a device that converts physical quantity to electrical signal such as audio sensor (such as microphone or the like), acceleration sensor, tilt sensor, infrared radiation sensor, depth sensor, temperature sensor, humidity sensor or the like. The input unit 915 may be a remote-control device that uses, for example, infrared radiation and another type of radio waves. Alternatively, the input unit 915 may be an external connection device 927 such as a mobile phone that corresponds to an operation of the information processing device 900. The input unit 915 includes an input control circuit that generates input signals on the basis of information which is input by a user to output the generated input signals to the CPU 901. The user inputs various types of data and indicates a processing operation to the information processing device 900 by operating the input unit 915.

The output unit 917 includes a device that can visually or audibly report acquired information to a user. The output unit 917 may be, for example, a display device such as an LCD, a PDP, and an OLED, an audio output device such as a speaker and a headphone, and a printer. The output unit 917 outputs a result obtained through a process performed by the information processing device 900, in the form of text or video such as an image, or sounds such as audio sounds.

The storage unit 919 is a device for data storage that is an example of a storage unit of the information processing device 900. The storage unit 919 includes, for example, a magnetic storage device such as a hard disk drive (HDD), a semiconductor storage device, an optical storage device, or a magneto-optical storage device. The storage unit 919 stores therein the programs and various data executed by the CPU 901, and various data acquired from an outside.

The drive 921 is a reader/writer for the removable recording medium 923 such as a magnetic disk, an optical disc, a magneto-optical disk, and a semiconductor memory, and built in or externally attached to the information processing device 900. The drive 921 reads out information recorded on the mounted removable recording medium 923, and outputs the information to the RAM 905. The drive 921 writes the record into the mounted removable recording medium 923.

The connection port 925 is a port used to directly connect devices to the information processing device 900. The connection port 925 may be a Universal Serial Bus (USB) port, an IEEE1394 port, or a Small Computer System Interface (SCSI) port, for example. The connection port 925 may also be an RS-232C port, an optical audio terminal, a High-Definition Multimedia Interface (HDMI (registered trademark)) port, and so on. The connection of the external connection device 927 to the connection port 925 makes it possible to exchange various kinds of data between the information processing device 900 and the external connection device 927.

The communication unit 929 is a communication interface including, for example, a communication device for connection to a communication network NW. The communication unit 929 may be, for example, a wired or wireless local area network (LAN), Bluetooth (registered trademark), or a communication card for a wireless USB (WUSB).

The communication unit 929 may also be, for example, a router for optical communication, a router for asymmetric digital subscriber line (ADSL), or a modem for various types of communication. For example, the communication unit 929 transmits and receives signals on the Internet or transmits signals to and receives signals from another communication device by using a predetermined protocol such as TCP/IP. The communication network NW to which the communication unit 929 connects is a network established through wired or wireless connection. The communication network NW is, for example, the Internet, a home LAN, infrared communication, radio wave communication, or satellite communication.

The imaging device (not shown) is a device that images real space using an imaging device such as a charge coupled device (CCD) or a complementary metal oxide semiconductor (CMOS), for example, and various members such as a lens for controlling image formation of a subject image on the imaging device and generates a captured image. The imaging device may capture a still picture or may capture a movie.

The present disclosure of the live streaming system 1 has been described with reference to embodiments. The above-described embodiments have been described merely for illustrative purposes. Rather, it can be readily conceived by those skilled in the art that various modifications may be made in making various combinations of the above-described components or processes of the embodiments, which are also encompassed in the technical scope of the present disclosure.

The procedures described herein, particularly flowchart or those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present disclosure.

In some embodiments, at least a part of the functions performed by the server 10 may be performed by other than the server 10, for example, being performed by the user terminal 20 or 30. In some embodiments, at least a part of the functions performed by the user terminal 20 or 30 may be performed by other than the user terminal 20 or 30, for example, being performed by the server 10. In some embodiments, the rendering of the frame image may be performed by the user terminal of the viewer, the server, the user terminal of the livestreamer or the like.

Furthermore, the system and method described in the above embodiments may be provided with a computer-readable non-transitory storage device such as a solid-state memory device, an optical disk storage device, or a magnetic disk storage device, or a computer program product or the like. Alternatively, the programs may be downloaded from a server via the Internet.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed but includes another variation and modification that do not disobey the present disclosure, and is the scope covered by the following patent application scope.

LIST OF REFERENCE NUMBERS

| | | | |
|---|---|---|---|
| 1 | Live streaming system | 10 | Server |
| 20 | User terminal | 100 | Streaming unit |
| 102 | Video control unit | 104 | Audio control unit |
| 106 | Distribution unit | 108 | UI control unit |
| 200 | Viewing unit | 202 | UI control unit |
| 204 | Rendering unit | 206 | Input unit |
| 30, 30a, 30b | User terminal | 302 | Providing unit |
| 304 | Relay unit | 306 | processing unit |
| 320 | Stream DB | 322 | User DB |
| 324 | Event DB | 326 | Historical record DB |
| 330 | Machine learning model | 332 | Machine learning model |
| 334 | event page | 346 | strategy page |
| 356 | event list page | 364 | ranking information |
| 366 | interaction log | 370 | hint messages |
| 372 | status | | |
| 600 | Screen | 604 | event object |
| 612 | livestreamer info object | 614 | livestreamer image |
| 616 | Message zone | 618 | message input box |
| 620 | game object | 622 | sharing object |
| 624 | event object 624 | 626 | strategy page |
| 900 | Information processing device | 901 | CPU |
| 903 | ROM | 905 | RAM |
| 907 | Host bus | 909 | Bridge |
| 911 | External bus | 913 | Interface |
| 915 | Input unit | 917 | Output unit |
| 919 | Storage unit | 921 | Drive |
| 923 | Removable recording medium | 925 | Connection port |
| 927 | External connection device | 929 | Communication unit |
| LS | Live streaming | LV | livestreamer |
| NW | Network | SP | Specific portion |
| AU1, AU2 | Viewer | | |
| S502-S532 | Step | | |
| VD, VD1, VD2 | Video | | |

What is claimed is:

1. A method for managing an event in a live streaming platform, comprising:
generating a summary of the event by machine learning models in response to a first operation from a user terminal of a user; wherein
the summary is generated according to information of the events, the user and the other users related to the user.

2. The method according to claim 1, further comprising:
generating a list of events according to winning rate of the user in the events in response to a second operation from the user terminal of the user; wherein
the winning rate is the user's possibility of winning the event or achieving a reward threshold in the event.

3. The method according to claim 2, wherein:
the winning rate is determined by at least one of the following parameters: similarity between the information of the events and the user, donation record of the user from the other user, winning record of the user on events.

4. The method according to claim 1, further comprising:
generating the summary further according to the input on request of the events from the user terminal of the user; wherein
the format of the summary is further determined according to the input.

5. The method according to claim 1, further comprising:
generating a hint message on guiding the user or the other users in the event by machine learning models; and
providing the user or the other users with the hint message during the period of the event.

6. The method according to claim 5, further comprising:
receiving status of the user in the event while the user being broadcasting; and
displaying the hint message during the broadcasting in response to a trigger being detected during the event; wherein
the hint message includes information on guiding the user or the other users in the event.

7. The method according to claim 5, wherein:
the hint message is generated according to the ranking information or interaction log of the same event the user is currently participating in, or similar event from historical event data.

8. The method according to claim 1, wherein:
the summary includes at least one of the following objects: suggestions on the events, video tutorial or AI real-time chatbot.

9. A server for managing events in a live streaming platform, comprising one or a plurality of processors, wherein the one or plurality of processors execute a machine-readable instruction to perform:
generating a summary of the event by machine learning models in response to a first operation from a user terminal of a user; wherein
the summary is generated according to information of the events, the user and the other users related to the user.

10. A non-transitory computer-readable medium including program instructions, that when executed by one or more processors, cause the one or more processors to execute:
generating a summary of the event by machine learning models in response to a first operation from a user terminal of a user; wherein
the summary is generated according to information of the events, the user and the other users related to the user.
